(19) United States
(12) Patent Application Publication
(10) Pub. No.: US 2025/0278714 A1
(43) Pub. Date: Sep. 4, 2025

(54) METHOD OF PROVIDING PARKING SYSTEM USING QR CODE AND PROXY PAYMENT

(71) Applicant: LightVision Inc., Seoul (KR)

(72) Inventors: Jin Ha JEONG, Yongin-si (KR); Moon Soo RA, Bucheon-si (KR); Hea Yun LEE, Suwon-si (KR); Hyun Ji LEE, Seoul (KR)

(21) Appl. No.: 19/213,092

(22) Filed: May 20, 2025

Related U.S. Application Data
(63) Continuation of application No. PCT/KR2023/017201, filed on Nov. 1, 2023.

(30) Foreign Application Priority Data
Nov. 25, 2022 (KR) 10-2022-0160133
Apr. 19, 2023 (KR) 10-2023-0051085

(51) Int. Cl. G06Q 20/32

(52) U.S. Cl. CPC G06Q 20/3276

(57) ABSTRACT

A method performed by a server for a parking system using CCTV and an AI algorithm or a parking system using a QR code and proxy payment comprises (a) transmitting parking area identification information from a user terminal to a server through capturing of a QR code installed to a parking area; (b) completing an entry by storing an entry time and the parking area identification information in the server when the user terminal transmits phone number, license plate number and payment means information, identifying stored location information related to the parking area identification information and transmitting an entry completion guidance message to the user terminal; (c) providing a proxy payment QR code to the user terminal according to request of the user terminal; and (d) identifying for a proxy payer terminal the proxy payment QR code from the user terminal, inputting proxy payment amount and performing proxy payment.

### CROSS-REFERENCE TO RELATED APPLICATIONS

This application is a bypass continuation of pending PCT International Application No. PCT/KR2023/017201, which was filed on Nov. 1, 2023, and which claims priority under 35 U.S.C 119(a) to Korean Patent Application No. 10-2022-0160133 filed with the Korean Intellectual Property Office on Nov. 25, 2022 and Korean Patent Application No. 10-2023-0051085 filed with the Korean Intellectual Property Office on Apr. 19, 2023. The disclosures of the above patent applications are incorporated herein by reference in their entirety.

### TECHNICAL FIELD

The disclosure relates to a method of providing a parking system using a QR code and proxy payment, more particularly relates to a method of providing proxy payment of parking fee, in which a CCTV image or QR code information is combined with an AI algorithm to allow a third party—such as a representative of the visited location or other persons—to pay part or all of the parking fee on behalf of the parker and a durable QR code plate as floor material installed in a portion of the parking area within the parking lot, enabling easy parking registration and ensuring service continuity.

### BACKGROUND ART

The issue of insufficient parking areas due to the increasing number of vehicles has been continuously raised. Public parking lots could serve as a solution, but selecting and securing appropriate land is not easy and incurs high costs. Even if the land is selected and a parking lot is constructed, additional operational expenses such as maintenance or labor costs arise. Moreover, if the parking lot is operated manually, there are limitations on operating hours.

In general, a parking system with a barrier bar requires vehicles to stop when entering and exiting the parking lot. In the case of exit, additional time is needed for payment, resulting in traffic congestion at the exit.

Additionally, for on-street parking lots or outdoor parking lots, a parking attendant had to check the entry time each time, and drivers had to pay the attendant when leaving, resulting in additional time being spent. Therefore, for public parking lots in places like markets with frequent vehicle turnover, it is practically impossible to manage the lot using a barrier bar.

Accordingly, a durable QR code plate, which is installed in a portion of the parking area to facilitate rapid parking registration and functions as floor material within the parking lot, has been required.

In the conventional parking fee payment process, visitors would receive a parking ticket from the location they visited and submit the parking ticket at a payment booth when exiting. Any additional charges had to be paid using a separate payment method, resulting in a cumbersome and inefficient experience.

Typical retail stores can provide free or discounted parking to visitors when utilizing the parking facilities of the building they occupy, but it is practically impossible to provide incentive-based services in outdoor or street-side parking lots.

Accordingly, there is a need for a system that allows proxy payment of parking fees, whereby the representative of the visited location or an accompanying person can cover part or all of the parking feet on behalf of the parker.

### SUMMARY

To solve problems of the conventional technique, the disclosure is to provide a method of providing proxy payment of parking fee generated in a parking management service that utilizes AI algorithms in combination with a CCTV image or QR code information, wherein a representative of the visited destination or an accompanying person performs the payment on behalf of the parker. Additionally, the disclosure is to provide a durable QR code plate installed in a portion of the parking area to facilitate rapid parking registration.

However, the technical problems to be solved by the present embodiment are not limited to those described above, and other technical problems may also exist.

A method of providing a parking system and proxy payment using a QR code executed by a server according to an embodiment of the disclosure includes: (a) transmitting parking area identification information from a user terminal to a server through capturing of a QR code installed to a parking area; (b) completing an entry by storing an entry time and the parking area identification information in the server when the user terminal transmits phone number, license plate number and payment means information to the server, identifying stored location information related to the parking area identification information and transmitting an entry completion guidance message to the user terminal; (c) providing a proxy payment QR code to the user terminal according to request of the user terminal; and (d) identifying for a proxy payer terminal the proxy payment QR code from the user terminal, inputting proxy payment amount and performing proxy payment.

The step of (d) includes: providing the difference between the proxy payment amount and payment amount to a service provider when multiple proxy payer terminals perform the proxy payment and the proxy payment amount exceeds the payment amount.

The difference between the proxy payment amount and the payment amount is divided by the number of proxy payer terminals that performed the proxy payment and the resulting amount is refunded when setting based on the same refund amount standard.

The difference between the proxy payment amount and the payment amount is refunded to the proxy payer terminals in proportion to the payment ratio of each proxy payer terminal relative to the proxy payment amount when setting to refund based on ratio of the proxy payment amount.

The method further includes: identifying the parking status of parking areas based on cameras installed around on-street parking lots, indoor parking lots and resident parking areas; providing corresponding information to a first user terminal when it is determined that two or more parking areas of a plurality of parking areas or the on-street parking lots within a specific area are vacant; requesting parking acceptance for one of two or more parking areas through a first user terminal; transmitting the requesting of the parking acceptance to a terminal of a registered resident corresponding to vacant parking area; and transmitting a reservation completion signal to the first user terminal when acceptance signals from a majority are received in response to the requesting of the parking acceptance. Here, the step of the providing, the step of requesting, the step of transmitting the requesting and the step of transmitting the reservation completion signal are performed before the step of (a), and the step of (b) includes analyzing patterns regarding entry and exit times of the registered resident to identify the registered resident corresponding to a vacant parking area and to derive available time information indicating how many hours the parking area will remain available.

The method further includes pre-storing, in the server, information on parking fee discount-eligible persons, including persons of national merit, persons with disabilities, parents of multiple children, and persons eligible for veteran benefits, as well as the license plate numbers of those eligible vehicles; identifying a vehicle in an image captured by a camera and generating an image learning model for recognizing a type of the identified vehicle (compact car and commercial vehicle). Here, the step of pre-storing and the step of identifying are performed before the step of (a).

The method further includes identifying vehicle information from an image transmitted from a camera of a parking lot, calculating automatically discount information regarding corresponding vehicle and paying automatically a parking fee to which discount is applied based on the calculating, after the step of (b).

The calculating includes: (p-1) applying at least one of electric vehicle discount, compact car discount, commercial vehicle discount, veteran discount, disability discount, and multiple-child parent discount based on one or more of the information about the fee discount objects stored in the server, the information concerning the kind of vehicle recognized through the image of the camera and color of a license plate recognized by the camera.

The QR code installed in the parking area is formed with a QR code plate. Here, the QR code plate includes a flooring plate, a notification layer on which a QR image is formed through a laser method of printing directly on the flooring plate, a LED method or an inkjet method; and a protection layer for protecting the notification layer on the notification layer.

A server for providing proxy payment for a parking fee according to an embodiment of the disclosure includes: a memory configured to store a program regarding a method of providing the proxy payment; and a processor configured to execute the program. Here, the method includes: (a) providing a QR code for the proxy payment according to request of a beneficiary terminal; (b) recognizing the QR code from the beneficiary terminal through a proxy payer terminal; (c) receiving, by the proxy payer terminal, a payment amount to be paid from the server, inputting proxy payment amount and performing the proxy payment; and (d) checking, by the beneficiary terminal, the updated payment amount from the server and paying the remaining amount.

The step of (d) includes: providing difference between the proxy payment amount and the payment amount to a service provider when multiple proxy payer terminals perform the proxy payment and the proxy payment amount exceeds the payment amount.

The difference between the proxy payment amount and the payment amount is divided by the number of proxy payer terminals that performed the proxy payment and the resulting amount is refunded when setting based on the same refund amount standard.

The difference between the proxy payment amount and the payment amount is refunded to the proxy payer terminals in proportion to the payment ratio of each proxy payer terminal relative to the proxy payment amount when setting to refund based on ratio of the proxy payment amount.

The server further includes: identifying the parking status of parking areas based on cameras installed around on-street parking lots, indoor parking lots and resident parking areas; providing corresponding information to a first user terminal when it is determined that two or more parking areas of a plurality of parking areas or the on-street parking lots within a specific area are vacant; requesting parking acceptance for one of two or more parking areas through a first user terminal; transmitting the requesting of the parking acceptance to a terminal of a registered resident corresponding to vacant parking area; and transmitting a reservation completion signal to the first user terminal when acceptance signals from a majority are received in response to the requesting of the parking acceptance. Here, the step of the providing, the step of requesting, the step of transmitting the requesting and the step of transmitting the reservation completion signal are performed before the step of (a), and the step of (b) includes analyzing patterns regarding entry and exit times of the registered resident to identify the registered resident corresponding to a vacant parking area and to derive available time information indicating how many hours the parking area will remain available.

The server further includes: pre-storing, in the server, information on parking fee discount-eligible persons, including persons of national merit, persons with disabilities, parents of multiple children, and persons eligible for veteran benefits, as well as the license plate numbers of those eligible vehicles; identifying a vehicle in an image captured by a camera and generating an image learning model for recognizing a type of the identified vehicle (compact car and commercial vehicle). Here, the step of pre-storing and the step of identifying are performed before the step of (a).

The server further includes identifying vehicle information from an image transmitted from a camera of a parking lot, calculating automatically discount information regarding corresponding vehicle and paying automatically a parking fee to which discount is applied based on the calculating, after the step of (b).

The calculating includes: (p-1) applying at least one of electric vehicle discount, compact car discount, commercial vehicle discount, veteran discount, disability discount, and multiple-child parent discount based on one or more of the information about the fee discount objects stored in the server, the information concerning the kind of vehicle recognized through the image of the camera and color of the license plate recognized by the camera.

The QR code installed in the parking area is formed with a QR code plate. Here, the QR code plate includes a flooring plate, a notification layer on which a QR image is formed through a laser method of printing directly on the flooring plate, a LED method or an inkjet method; and a protection layer for protecting the notification layer on the notification layer.

The disclosure may provide a method for providing proxy payment of parking fee generated by a parking management service that utilizes an AI algorithm in combination with a CCTV image or QR code information and a durable QR code plate which is installed in a portion of the parking lot and printed in various configurations.

### BRIEF DESCRIPTION OF DRAWINGS

Example embodiments of the disclosure will become more apparent by describing in detail example embodiments of the disclosure with reference to the accompanying drawings, in which:

FIG. 1 is a view illustrating an AI-based parking system using a QR code according to an embodiment of the disclosure;

FIG. 2 is a view illustrating a server according to an embodiment of the disclosure;

(A) in FIG. 3 is a view illustrating an AI-based parking system using a CCTV of a parking lot with installed camera according to another embodiment of the disclosure;

(B) in FIG. 3 is a view illustrating an AI-based parking system using a QR code of a parking lot with installed camera according to another embodiment of the disclosure;

FIG. 4 is a diagram illustrating operational flow of an AI-based parking system using QR code according to an embodiment of the disclosure;

FIG. 5 is a flowchart illustrating operation of an AI-based parking system using a QR code according to an embodiment of the disclosure;

FIG. 6 is a view illustrating an example of parking and exit process in the AI-based parking system using a QR code according to an embodiment of the disclosure;

FIG. 7 is view illustrating an example of a QR code used in an AI-based parking system using the QR code according to an embodiment of the disclosure;

FIG. 8 is a view illustrating an entry process of an AI-based parking system using a QR code according to an embodiment of the disclosure;

(A) in FIG. 9 is a view illustrating an example of recognition of additional identification code adhered to a parking lot by a user terminal according to an embodiment of the disclosure;

(B) in FIG. 9 is a view illustrating an example of guidance information for exit in an AI-based parking system using QR code according to an embodiment of the disclosure;

FIG. 10 is a view illustrating an exit process of an AI-based parking system using a QR code according to an embodiment of the disclosure;

FIG. 11 is a flowchart illustrating operation of an AI-based parking system using QR code of a parking lot with installed camera according to another embodiment of the disclosure;

FIG. 12 is a view illustrating an example of parking and exit process in an AI-based parking system using a QR code in a parking lot in which a camera is installed according to a second embodiment of the disclosure;

FIG. 13 is a view illustrating an example of searching of a parking lot and guidance of vacant parking area in an AI-based parking system using a QR code of the parking lot with installed parking camera according to a second embodiment of the disclosure;

FIG. 14 is a view illustrating an application of an AI-based parking system using QR code according to an embodiment of the disclosure;

FIG. 15 is a flowchart illustrating a process of performing machine learning to recognize license plate number through a camera in inclement weather according to another embodiment of the disclosure;

FIG. 16 is a view illustrating a process of recognizing text of a license plate through a camera in a method of providing a parking system using a QR code based on accurate recognition of the license plate according to another embodiment of the disclosure;

FIG. 17 is a view illustrating an example of a defect image in a snowy or rainy weather in a method of providing a parking system using a QR code based on accurate recognition of a license plate according to another embodiment of the disclosure;

FIG. 18 is a view illustrating a process of providing an automatic parking discount service of parked vehicle according to another embodiment of the disclosure;

FIG. 19 is a flowchart illustrating a process of providing an automatic parking discount service of parked vehicle according another embodiment of the disclosure;

FIG. 20 is a view illustrating a table for determining payment fee of an automatic parking discount service of parked vehicle according to another embodiment of the disclosure;

FIG. 21 is a view illustrating layers of a QR code plate applying UV printing, laser printing, inkjet printing or LED printing, installed on a parking area in an automatic discount parking service of parked vehicle according to another embodiment of the disclosure; and

FIG. 22 is a view illustrating a process that an outsider performs in a resident parking area according to another embodiment of the disclosure.

### DETAILED DESCRIPTION

Example embodiments of the present invention are disclosed herein with reference to accompanying drawings. However, specific structural and functional details disclosed herein are merely representative for purposes of describing example embodiments of the present invention, however, example embodiments of the present invention may be embodied in many alternate forms and should not be construed as limited to example embodiments of the present invention set forth herein. Like numbers refer to like elements throughout the description.

It will be understood that when an element is referred to as being “connected” or “coupled” to another element, it can be directly connected or electrically coupled to the other element or intervening elements may be present. Additionally, when it is stated that a particular part “includes” certain components, unless otherwise specified, this means that other components may also be included in addition to those mentioned.

In this specification, the term ‘unit’ encompasses units realized by hardware, units realized by software, and units realized by both hardware and software. Additionally, one unit may be implemented using more than one piece of hardware, and multiple units may be implemented using a single piece of hardware. The term ‘˜unit’ does not limit itself to software or hardware; it can also be structured to reside in addressable storage media and may be configured to be executed by one or more processors. Therefore, as an example, ‘˜unit’ includes software components such as objects, object-oriented software components, classes, tasks, functions, procedures, subroutines, segments of program code, drivers, firmware, microcode, circuits, data, databases, data structures, tables, arrays, and variables. The functions provided within the units and components can be combined into smaller numbers of components and units or further separated into additional components and units. Furthermore, the components and units may be implemented to be executed by one or more CPUs within a device or secure multimedia card.

Hereinafter, the “user terminal” referred to is a computer or portable terminal that can access servers or other terminals via a network. A computer, in this context, may include laptops, desktops, and VR HMDs equipped with web browsers, such as HTC VIVE, Oculus Rift, GearVR, DayDream, and PSVR. This encompasses both PC-based VR HMDs (e.g., HTC VIVE, Oculus Rift, FOVE, Deepon) and mobile-based ones (e.g., GearVR, DayDream, google's card-board), as well as standalone models (e.g., Deepon, PICO). Portable terminals refer to wireless communication devices that ensure portability and mobility, including smartphones, tablet PCs, wearable devices, and various devices equipped with communication modules like Bluetooth (BLE), NFC, RFID, ultrasonic, infrared, WiFi, and LiFi. The term “network” refers to a structure that allows information exchange between nodes such as terminals and servers, encompassing LAN (Local Area Network), WAN (Wide Area Network), the Internet (WWW), wired and wireless data communication networks, telephone networks, and wired and wireless television communication networks. Examples of wireless data communication networks include 3G, 4G, 5G, 3GPP (3rd Generation Partnership Project), LTE (Long Term Evolution), WIMAX (Worldwide Interoperability for Microwave Access), WiFi, Bluetooth communication, infrared communication, ultrasonic communication, VLC (Visible Light Communication), and LiFi, but are not limited to these.

### Parking Payment Service

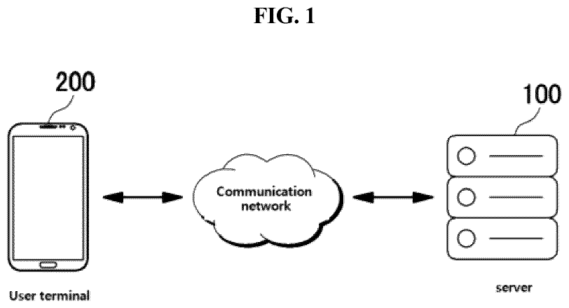

Hereinafter, a system according to an embodiment of the disclosure will be described with reference to a drawing FIG. 1.

In FIG. 1, a system of the present embodiment includes a server 100 and a user terminal 200.

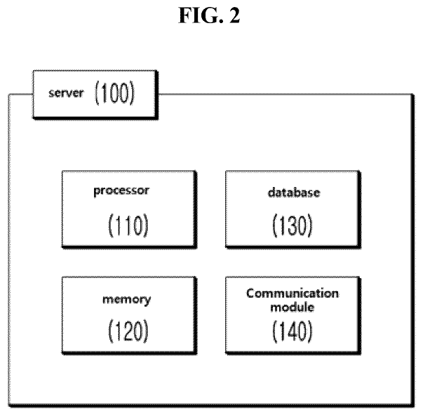

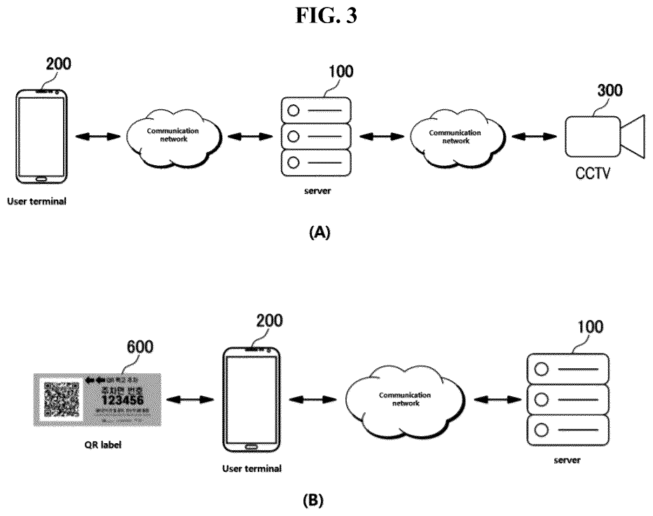

The server 100 will be described with reference to accompanying a drawing FIG. 2. In FIG. 2, the server 100 includes a processor 110, a memory 120, a database 130 and a communication module 140.

The processor 110 executes a parking program stored in the memory 120 such that the user terminal 200 performs entry, exit and payment processes. The database 130 stores parking information inputted through the user terminal 200 when a vehicle enters, wherein the parking information includes portable phone number, license plate number or encrypted payment card information. The communication module 140 communicates with the user terminal 200 to provide a parking system when the user terminal 200 accesses a parking application or a parking webpage to receive an AI (artificial intelligence)-based parking system.

The user terminal 200 accesses the parking application or the parking webpage by scanning a QR code provided in a parking lot and performs entry, exit and fee payment processes through the parking application or the parking webpage.

### CCTV-Based Parking Payment Service

Hereinafter, the AI-based parking system using the CCTV of the parking lot where a parking camera is installed according to a second embodiment of the disclosure will be described with reference to a drawing FIG. 3.

In (A) of FIG. 3, the parking system of the present embodiment includes the server 100, the user terminal 200 and a CCTV 300.

The CCTV 300 can also be referred to as a camera, constantly monitor the parking lot, and transmit vacant parking area in the parking lot, the identification information and location of the vacant parking area to the server 100. In the event that a vehicle arrives at the parking lot and enters the vacant parking area, the CCTV 300 may recognize license plate and an entry time and transmit the recognized license plate and entry time to the server 100. Next, when the vehicle leaves the parking area, the CCTV 300 may recognize the license plate and an exit time and transmit the recognized license plate and exit time to the server 100.

Here, the CCTV 300 or the server 100 may transmit information concerning the location of the parking area to the user terminal 200 such that the information is displayed on a map.

The description about the server 100 and the user terminal 200 will be based on the content explained in FIG. 1. Hereinafter, we will focus on explaining the content not mentioned in FIG. 1.

The server 100 may provide various information of the parking lot transmitted from the camera according to request of an application of the user terminal 200. This will be described in detail with reference to accompanying a drawing FIG. 9.

### Parking Payment Service Based on a QR Code

Hereinafter, an AI-based parking system using a QR code of a parking lot with installed parking camera according to another embodiment of the disclosure will be described with reference to accompanying a drawing (B) of FIG. 3.

In B of FIG. 3, the parking system of the present embodiment includes a server 100, a user terminal 200 and a QR printed label 600.

The description about the server 100 and the user terminal 200 will be replaced with description in A of FIG. 3.

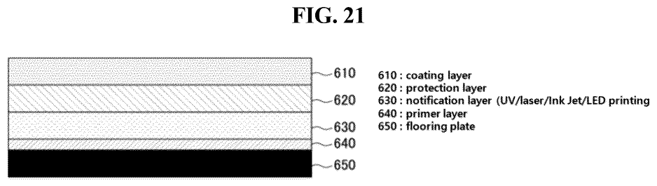

The QR printed label 600 is installed on a portion of a parking area within the parking lot to facilitate easy parking registration, and it is formed of durable flooring material to ensure the sustainability of the parking service. The QR printed label 600 will be described below with reference to accompanying a drawing FIG. 21.

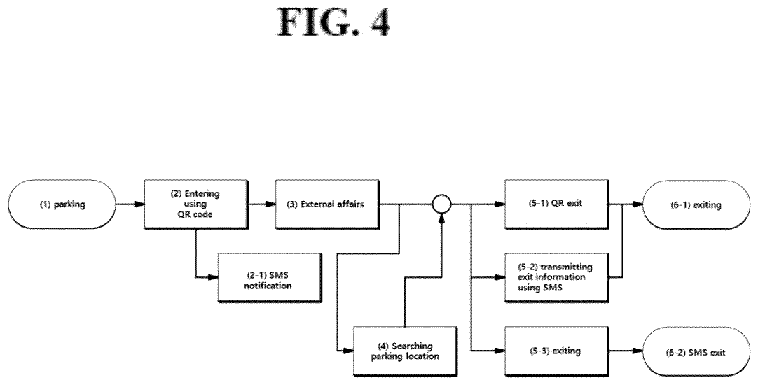

Hereinafter, operational flow of the AI-based parking system using the QR code according to an embodiment of the disclosure will be described with reference to accompanying a drawing FIG. 4.

If a vehicle enters using QR code in a parking lot in a step of 1 and a step of 2, SMS notification is received in a step of 2-1, and a user performs external affairs in a step of 3. The user searches parking location for exit when the user returns in a step of 4, the exit is performed by capturing a QR code in a step of 5-1, is performed by transmitting exit information using SMS in a step of 5-2, or is performed by leaving the parking lot in a step of 5-3. In the steps of 5-1 and 5-2, the server processes the exiting. In the step of 5-3, the camera in the parking lot recognizes the exited vehicle and processes automatically the exiting. In a step of 6-2, the server may transmit an exit completion notification to the user terminal via SMS.

Hereinafter, general description of the disclosure will be described in detail with reference to accompanying drawings.

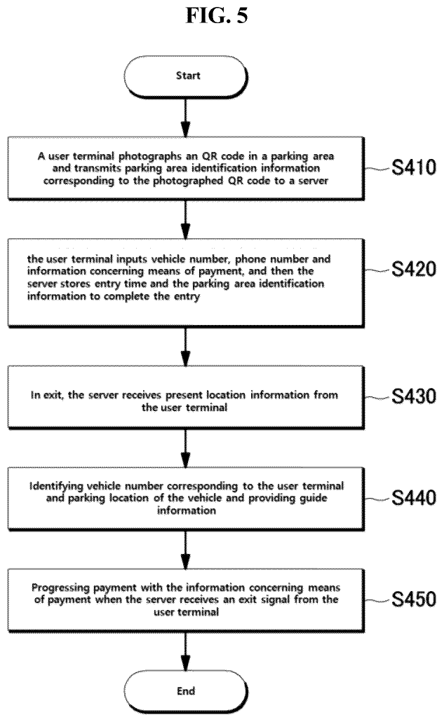

An AI-based parking system using a QR code in a large-area parking lot where a barrier bar and a parking camera don't exist will be described in detail with reference to accompanying a drawing FIG. 5.

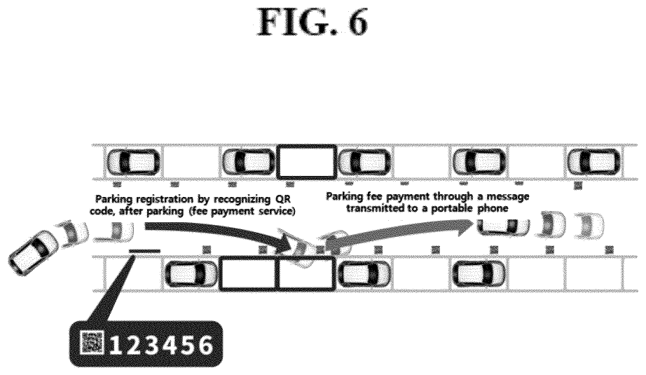

FIG. 6 shows an example of entry, exit and payment processes in the AI-based parking system.

In a step of S410, the user terminal 200 photographs QR code of a parking area and transmits parking area identification information corresponding to the scanned QR code to the server 100. In a step of S420, the user terminal 200 inputs license plate, phone number and payment means information, and then the server 100 stores an entry time and the parking area identification information to complete the entry.

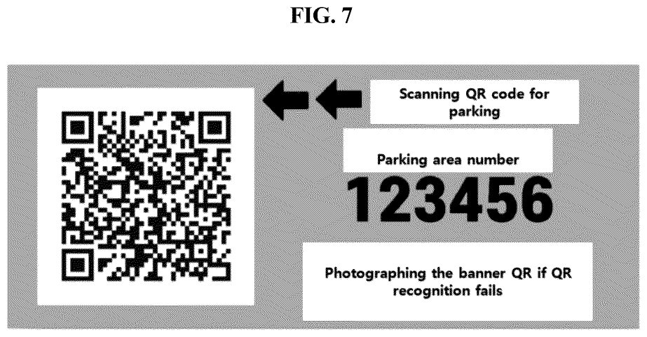

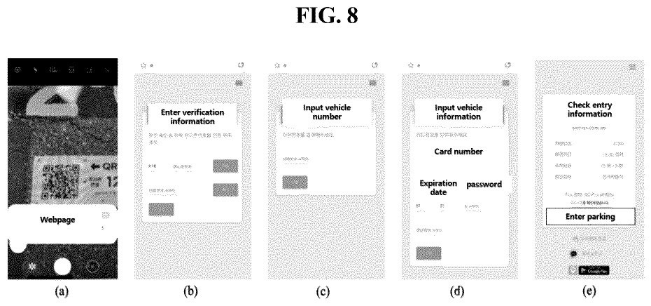

Hereinafter, a detailed process in the steps of S410 and S420 will be described with reference to accompanying drawings FIG. 7 to FIG. 8.

FIG. 7 is view illustrating an example of a QR code used in an AI-based parking system using the QR code according to an embodiment of the disclosure. The QR code may be referred to as the QR printed label 600.

In the large-area parking lot where the barrier bar is not installed at a parking entrance and the parking camera does not exist, a vehicle enters in vacant parking area in the parking lot and then a driver scans QR code shown on a ground or a wall of the parking lot using the user terminal 200. The QR code includes the parking area identification information, and the user terminal 200 transmits the parking area identification information corresponding to the scanned QR code to the server 100.

FIG. 8 is a view illustrating an entry process of an AI-based parking system using a QR code according to an embodiment of the disclosure.

In the step of S410, in the event that the user terminal 200 transmits the parking area identification information corresponding to the QR code to the server 100, the server 100 transmits URL address accessing a webpage to the user terminal 200 such that the URL address is shown on an area of the user terminal 200. The user terminal 200 accesses the webpage by inputting the URL address transmitted from the server 100.

If the access to the webpage is completed, a screen shown in (b) of FIG. 8 is displayed. The user terminal 200 requests a verification code to the server 100 after inputting phone number, receives the verification code from the server 100 and inputs the received verification code.

If the inputting of the phone number and the verification code is completed, a screen for inputting license plate is displayed as shown in (c) in FIG. 8, and the user terminal 200 inputs the last four digits or whole of the license plate.

If the inputting of the license plate is completed, a screen for inputting payment means information is displayed as shown in (d) in FIG. 8, and the user terminal 200 inputs card number, expiration date, the first two digits of the password and date of birth.

If the inputting of the payment means information is completed, a final step for entry starts, the entry is completed when the user selects “enter parking” and the payment means information is stored and matched with entry time and parking area identification information.

In a step of S440, in exit, the server 100 receives current location information from the user terminal 200. In a step of S440, the server 100 identifies the license plate corresponding to the user terminal 200 and parking location of the vehicle and provides guidance information.

The step of S430 will be described with reference to accompanying a drawing (A) in FIG. 9. In (A) in FIG. 9, each parking spot has a printed label attached, which comprises an additional identification code including information about its current location within the parking lot. The server 100 transmits information concerning current location to the user terminal 200 when the user terminal 200 recognizes the additional identification code and transmits the recognized additional identification code to the server 100. Or, the user terminal 200 transmits its GPS value to the server 100. The server 100 identifies the license plate corresponding to the user terminal 200 and the parking location of the vehicle and then provides the guidance information. The guidance information is provided in three different ways.

In a first way, the server 100 displays the current location, the parking location and a moving path on a parking map and provides the displayed map to the user terminal 200. The server 100 provides a parking layout to the user terminal 200, displays current location of the user terminal 200 and the parking location of the vehicle corresponding to the user terminal 200 on the parking layout and displays a moving path from the current location to the parking location as a line on the parking layout. The user terminal 200 displays its current location on the moving path by using at least one of a GPS, an accelerometer and a gyroscope.

A second way and a third way will be described with reference to accompanying drawing (B) in FIG. 9.

(B) in FIG. 9 is a view illustrating an example of guidance information for exit in an AI-based parking system using a QR code according to an embodiment of the disclosure.

In the second way, the user terminal 200 shows a moving path through an AR image while the user terminal 200 is in camera mode. The moving path is shown using an arrow in the AR image on the screen while the user terminal 200 is in the camera mode as shown in (a) in (B) of FIG. 9, and the driver moves along the arrow shown on the user terminal 200. In this time, the user terminal 200 may display next directional arrow for the moving path by using at least one of the GPS, the accelerometer and the gyroscope.

In the third way, the user terminal 200 displays the moving path through the AR image while the user terminal 200 is in the camera mode, wherein identification information for parking location is displayed in only a direction of the parking location on the AR image. The driver may move in a direction in which corresponding AR image is continuously displayed to reach the parking area when the AR image is viewed through a 360-degree rotation on the user terminal 200.

In the event that the user terminal 200 is in camera mode and is rotated 360 degrees, identification information for the parking location is displayed in the direction corresponding to the parking area on a portion of the user terminal 200 as shown in (b) in (B) of FIG. 9. The driver refers to the identification information displayed on the user terminal 200 and moves in the indicated direction to reach the parking area.

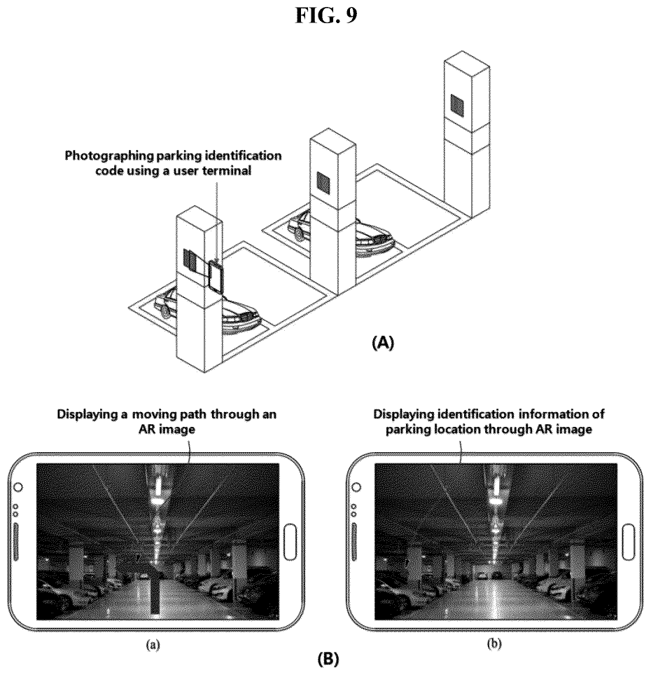

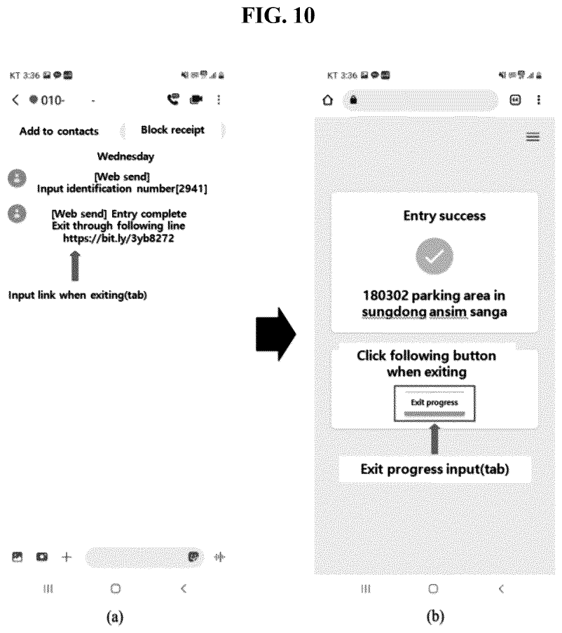

In a step of S450, the server 100 proceeds payment with the payment means information when it receives an exit signal from the user terminal 200. The server 100 performs the payment process for exit when the driver reaches the parking area at which the vehicle parks through the step of S440. This will be described with reference to accompanying a drawing FIG. 10.

(a) in FIG. 10 shows a screen of exit URL provided as a message when the entry is completed in the step of S420. The screen is shifted to an exit page as shown in (b) in FIG. 10 when URL link is selected for the exit, an entry success message is displayed on the screen, and the payment is performed with the payment means information inputted in the step of S420 when exit progress displayed on the screen is inputted through tab.

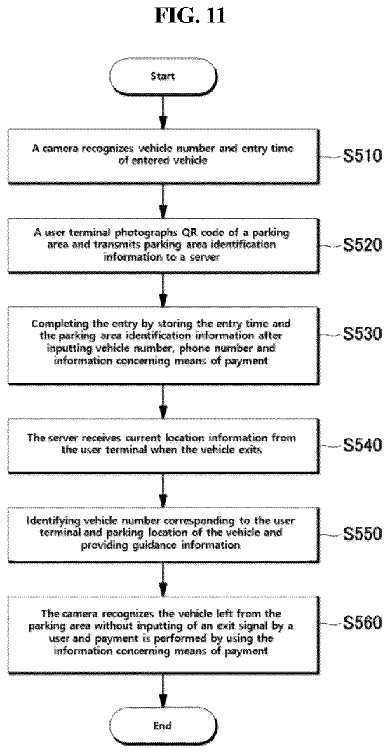

Hereinafter, an operation of an AI-based parking system using a QR code in a resident priority parking area in which a barrier bar does not exist but a camera is installed will be described in detail with reference to a drawing FIG. 11.

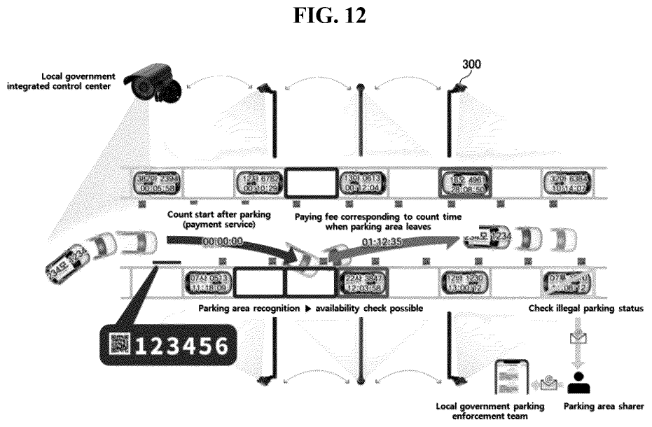

FIG. 12 shows an example of entry, exit and payment processes in an AI-based parking system using a QR code in a parking lot with installed camera according to a second embodiment of the disclosure.

In a step of S510, a camera recognizes the license plate and the entry time of entered vehicle.

A camera employed in local government or government office is installed in a resident priority parking area where a barrier bar is not installed at an entrance. The camera may capture the parking lot 24 hours a day for security monitoring. Here, in the event that a vehicle reaches the parking lot, the camera installed in the parking lot may recognize license plate and an entry time of the vehicle entering in vacant parking area.

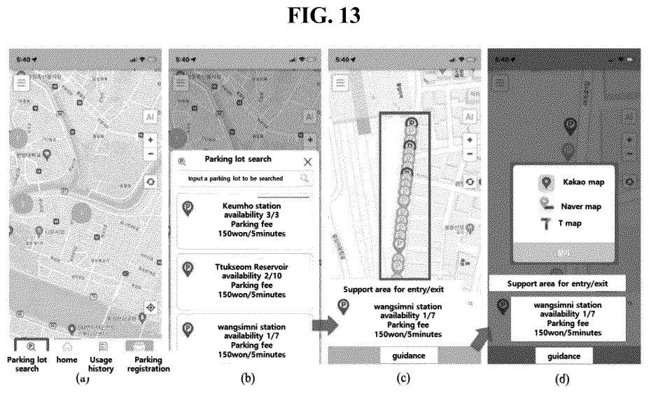

In another embodiment, in the event that an application is installed to the user terminal 200, a user may check location of the parking lot and whether or not vacant parking area exists through the application before the step of S510 and receive a moving path from current location of the vehicle to the parking lot. This will be described with reference to accompanying a drawing FIG. 13.

Referring to FIG. 13, the parking system according to a second embodiment of the disclosure may explain how to locate the parking lot and guide the user to an available parking area before entering the AI-powered parking lot, which utilizes a QR code and is equipped with parking cameras.

(a) in FIG. 13 shows number of available parking area displayed on a map of an application, and the user may search the parking lot through a parking lot search displayed in a lower region.

Referring to (b) in FIG. 13, the user may verify a parking lot list corresponding to input of the parking lot search by the user terminal 200. The list includes name, address, indoor or outdoor, operating hours, parking fee, total available number of vehicles and current available number of vehicles, for the parking lot.

In the event that the user terminal 200 selects the available number, a parking area of corresponding parking lot may be displayed on the user terminal 200 as shown in (c) in FIG. 13, and the user may check vacant parking area, identification information of the vacant parking area and location of the vacant parking area through a camera. The server 100 may display information concerning the location of the vacant parking area on the map and provide the map on which the information is displayed to the user terminal 200.

In the event that the user terminal 200 selects guidance located on its lower portion in (c) of FIG. 13, the user may get a service for providing a path guidance from current location of the user terminal 200 to the vacant parking area as shown in (d) of FIG. 13. The user terminal 200 receives the path guidance by selecting the service preset to the user terminal 200 of plural services.

In a step of S520, the user terminal 200 captures a QR code of the parking area and transmits parking area identification information to the server 100. In a step of S530, the entry is completed by storing the entry time and the parking area identification information after inputting license plate, phone number and payment means information. In a step of S540, in exit, the server 100 receives current location information from the user terminal 200. In a step of S550, the server 100 identifies license plate corresponding to the user terminal 200 and parking location of the vehicle and provides guidance information.

The steps of S520 to S550 will be replaced with the steps of S410 to S440 in FIG. 5.

In a step of S560, the camera recognizes the vehicle left from the parking area without inputting of an exit signal by a user and payment is automatically performed by using the payment means information.

The camera recognizes the identification information of the vehicle when a driver reaches the parking area and leaves the parking area without inputting extra exit signal and obtains an exit time of the vehicle. The server 100 verifies license plate corresponding to license plate of the exited vehicle of license plates pre-stored in the step S510 and the entry time when the camera transmits the recognized license plate and the exit time, and calculates a parking time based on the entry time and the exit time. The server 100 performs automatically the payment by using the payment means information pre-inputted in the step S530.

The server 100 may transmit a payment completion message to a user terminal corresponding to the phone number inputted in the step S530 when the payment is automatically performed.

A process in the AI-based parking system using the QR code in a large-area parking lot where the barrier bar does not exist and but the camera exists according to a third embodiment of the disclosure is the same as in the process in the second embodiment.

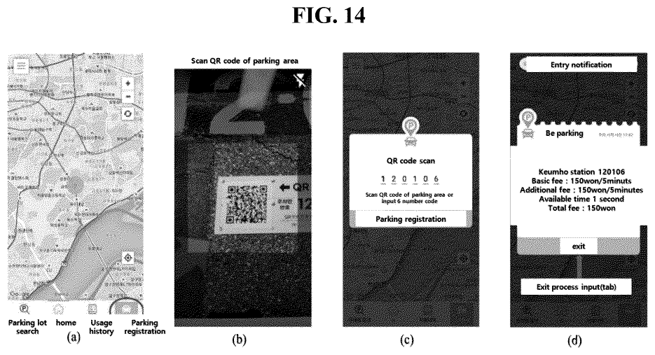

In still another embodiment, in the event that an application is installed to the user terminal 200, the entry may be performed without performing the step S420 in FIG. 5 and the step S530 in FIG. 11 when license plate, phone number and payment means information are pre-stored in the application. This will be described with reference to accompanying a drawing FIG. 14.

FIG. 14 is a view illustrating an application of an AI-based parking system using a QR code according to an embodiment of the disclosure.

A user locates a vehicle in a parking area, executes the application of the user terminal 200, selects a parking registration displayed on a portion of the application as shown in (a) of FIG. 14, and identifies the QR code using the user terminal 200 as shown in (b) of FIG. 14. An entry is completed as shown in (d) of FIG. 14 when the user checks a number of the parking area provided from the application and selects the parking registration as shown in (c) of FIG. 14. Here, license plate, phone number and payment means information are pre-stored in installed application, and thus it is not necessary to input them through an extra process.

In another embodiment, in the event that a controller of a vehicle and the user terminal 200 are connected via a local area network and a rearview camera image is displayed on a center fascia screen as the vehicle performs reverse parking. In the event that an image including a QR code of the rearview camera images is detected, the vehicle transmits the image including the QR code to the user terminal 200. The user terminal 200 may extract the QR code from the image transmitted from the vehicle, access automatically a related link, and transmit parking area identification information included in the QR code and phone number of the user terminal 200 to the server 100. As a result, a driver may complete the entry without an extra action.

In another embodiment, in the event that the controller of the vehicle and the user terminal 200 are connected via a local area network, the rearview camera image is displayed on the center fascia screen as the vehicle performs reverse parking. In the event that an image including a QR code of the rearview camera images is detected, the user captures the image through the user terminal 200. The user terminal 200 may access a link related to the QR code in the image captured by the user terminal 200 and transmit the parking area identification information included in the QR code and the phone number of the user terminal 200 to the server 100.

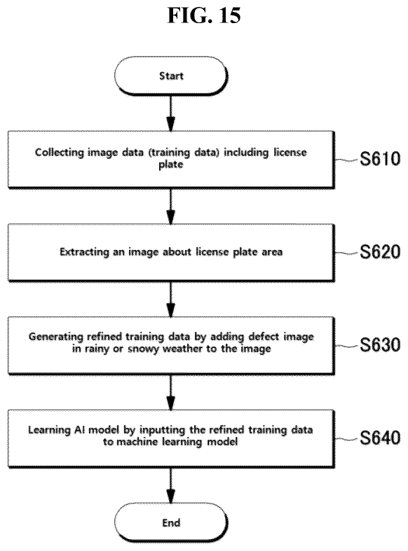

In still another embodiment, the camera may recognize the license plate through machine learning in inclement weather. This will be described in detail with reference to accompanying a drawing FIG. 15.

FIG. 15 is a flowchart illustrating a process of performing machine learning to recognize license plate number through a camera in inclement weather according to another embodiment of the disclosure.

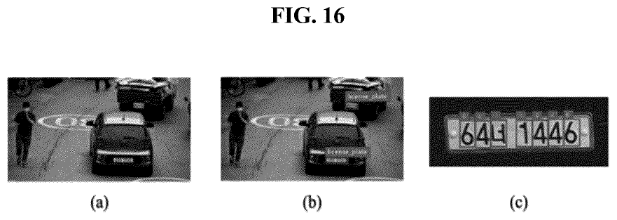

An image data (training data) including a license plate is collected in a step of S610, and an image about license plate area is extracted in a step of S620. The steps S610 and S620 will be described with reference to accompanying a drawing FIG. 16. FIG. 16 is a view illustrating a process of collecting the image data including the license plate through the camera and extracting the image about the license plate area. The camera may detect location of the license plate in the vehicle as shown in (b) of FIG. 16 when the vehicle passes as shown in (a) of FIG. 16. The camera may distinguish and recognize individual numbers and letters within the license plate area, extract the corresponding images, and identify the full license plate by combining the recognized numbers and letters, as shown in (c) of FIG. 16.

In a step of S630, the camera generates refined training data by adding defect image in rainy or snowy weather to the image. Since there are limitations in obtaining defect images under actual rainy or snowy weather, the camera may place individual defect images with different sizes at different positions within the extracted image area.

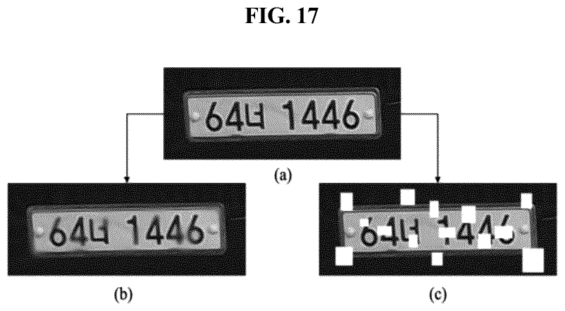

Referring to FIG. 17, raindrops may be simulated by partially applying a blind effect as shown in (b) of FIG. 17 to a normal license plate shown in (a) of FIG. 17. Heavy snowfall may be simulated by arbitrarily placing white rectangular-shaped defects in specific regions of the license plate image as shown in (c) of FIG. 17. However, the form of the artificially added defects is not limited to the aforementioned example.

Size of the defect image is smaller than that of the extracted image area, and thus the defect images blinds regions of the license plate. Multiple refined training data corresponding to one license plate may be generated when the defect image has plural shapes and colors.

In a step of S640, an AI model is trained by inputting the refined training data to a machine learning model. Incorporating simple defects into the refined training data enables the AI model to recognize accurately the license plate even when numbers (or characters) are partially occluded, rather than only when they are fully visible. Furthermore, due to the simplicity of the defects, there is no significant increase in training time.

### Proxy Payment of Parking Fee

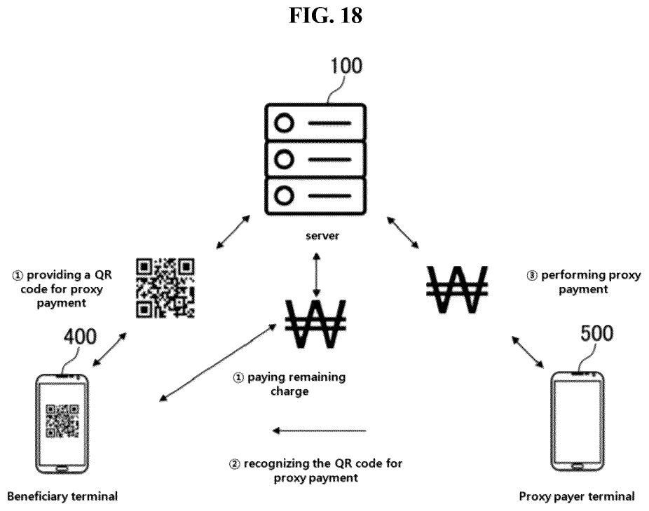

In a parking system according to another embodiment of the disclosure, another person may pay parking fee on behalf of a driver of a vehicle. This will be described in detail with reference to accompanying drawings FIG. 18 to FIG. 20.

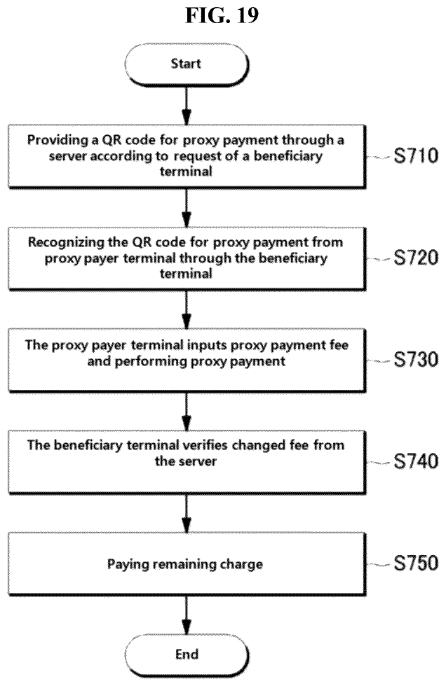

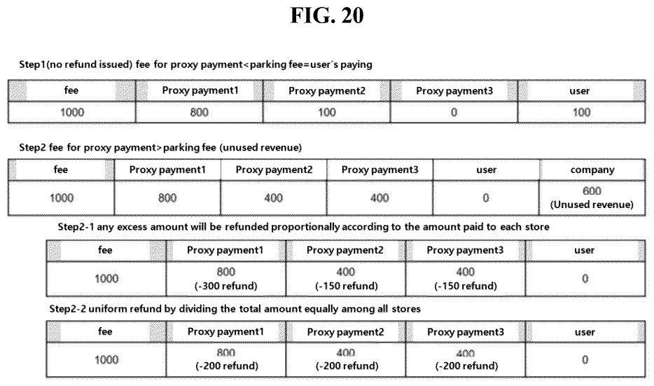

FIG. 18 is a view illustrating a process of providing an automatic parking discount service of parked vehicle according to another embodiment of the disclosure. FIG. 19 is a flowchart illustrating a process of providing an automatic parking discount service of parked vehicle according another embodiment of the disclosure. FIG. 20 is a view illustrating a table for determining payment fee of an automatic parking discount service of parked vehicle according to another embodiment of the disclosure.

In the description below, the beneficiary includes the driver who has parked in the parking lot. The proxy payer can be any entity willing to pay the parking fee on behalf of the beneficiary, such as a store owner, a friend of the driver, etc. There are three methods for proxy payment: equal distribution of the total amount, store-based proportional distribution, and unused income (residual revenue).

In FIG. 18, the automatic discount parking service of parked vehicle according to another embodiment of the disclosure is performed among a server 100, a beneficiary terminal 400 and a proxy payer terminal 500, and includes (1) providing a QR code for proxy payment, (2) recognizing the QR code for proxy payment, (3) performing proxy payment and (4) paying remaining charge in sequential order. This will be described in detail with reference to accompanying a drawing FIG. 19.

In a step of S710, the server provides a QR code for proxy payment according to request of the beneficiary terminal 400. Here, the beneficiary terminal 400 may be a terminal of a person requesting proxy payment, e.g. a business visitor, a customer, etc. However, the person requesting the proxy payment is not limited as above person. The server provides the QR code to the beneficiary terminal 400 when the beneficiary terminal 400 accesses the server to discount parking fee.

In a step of S720, the proxy payer terminal 500 recognizes the QR code for proxy payment from the beneficiary terminal 400. The proxy payer terminal 500 recognizes the QR code by capturing the QR code shown on a display of the beneficiary terminal 400 using a camera connected to the proxy payer terminal 500.

In an embodiment, the proxy payer terminal 500 may perform the proxy payment by inputting multiple numbers higher than 0 corresponding to the QR code provided to the beneficiary terminal 400 by using an application provided by the server.

In a step of S730, the proxy payer terminal 500 inputs proxy payment fee and then perform the proxy payment. The proxy payer terminal 500 inputs fee to be paid and then perform the payment by using a payment means. Here, the payment means may be pre-stored payment means. Two or more proxy payer terminals not one proxy payer terminal may be used. The proxy payer terminal 500 is not limited to being used by a store owner or a representative of the visited location, and it may also be utilized by an individual who wishes to pay a parking fee on behalf of a friend or by an employer intending to cover an employee's parking fee.

Refund may occur depending on a process in the event that multiple proxy payer terminals 500 are used. This will be described with reference to accompanying a drawing FIG. 20.

In FIG. 20, it is verified that a user (beneficiary terminal 400), proxy payment1, proxy payment2 and proxy payment3 perform payment. Here, the user is referred to as the beneficiary terminal 400 and the proxy payment is referred to as the proxy payer terminal 500.

If the beneficiary terminal 400 visits multiple locations and receives proxy payments from multiple proxy payer terminals 500 and the total amount of proxy payments exceeds the actual payment amount, the entire difference between the proxy payments and the payment amount may be retained by the service provider as unused revenue (residual income).

### 1. No Refund Issued

In the event that multiple proxy payer terminals 500 perform proxy payments, a process 1 is as follows: If the payment amount is 1,000 KRW and the first to third proxy payer terminals perform proxy payments, paying 800 KRW, 100 KRW, and 0 KRW respectively, a total of 900 KRW is paid via proxy payment. Since the total amount 900 KRW paid by the proxy payments does not exceed the payment amount 1,000 KRW, the beneficiary terminal 400 may pay the remaining 100 KRW, which is the difference between the payment amount and the total proxy payment. In this case, no refund occurs.

### 2. Refund Method by Store for Overpaid Amounts

In the event that multiple proxy payer terminals 500 perform proxy payment and a total payment amount of 1,000 KRW is required in a process 2, a total of 1,600 KRW is paid if a first proxy payer terminal, a second proxy payer terminal and a third proxy payer terminal respectively perform proxy payments of 800 KRW, 400 KRW, and 400 KRW. In this case, since the total proxy payment amount 1,600 KRW exceeds the required payment amount 1,000 KRW, there remains no amount to be paid by the beneficiary. Accordingly, a refund process may be carried out for the excess amount 600 KRW to the respective proxy payer terminals.

### 2-1. Refund Distributed in Proportion to the Respective Proxy Payment Amounts

The basis for the refund may be classified according to the following cases. First, in the event that the refund of the excess amount is configured to be performed based on the proportion of the proxy payment amounts, the unused amount may be refunded to each proxy payer terminal in proportion to the respective paid proxy payment amount. For example, when the total proxy payment amount is 1,600 KRW and the proxy payer terminals 500 have respectively paid 800 KRW, 400 KRW, and 400 KRW, the unused amount of 600 KRW may be refunded in accordance with the ratio of each proxy payment. As a result, refunds of 200 KRW, 150 KRW, and 150 KRW may be provided to the respective proxy payer terminals 500.

### 2-2. Uniform Refund Amount

Next, in the event that the refund is configured based on uniform refund amount, the difference of 600 KRW may be uniformly refunded to the proxy payer terminals 500 when the total proxy payment amount is 1,600 KRW and the payment amount is 1,000 KRW. Accordingly, each of the proxy payer terminals 500 may receive a refund of 200 KRW.

The beneficiary terminal 400 verifies changed fee from the server in a step of S740, and it pays verified remaining fee in a step of S750.

The beneficiary terminal 400 may request payment amount information to the server in order to perform a payment process, and may check payment amount provided from the server. In the event that, in the step S730, the proxy payer terminal 500 have fully paid the payment amount, the beneficiary terminal 400 may omit the payment process. However, if there remains a residual fee to be paid in step S730 after the proxy payer terminals 500 have completed their respective payments, the beneficiary terminal 400 may confirm the remaining fee and proceed with the payment using a payment means. In this case, a previously stored payment means may be utilized.

### QR Code Plate

Hereinafter, with reference to FIG. 21, a description will be provided regarding the layers constituting a QR code plate, which is installed in a parking area in the automatic discount parking service of parked vehicle according to another embodiment of the disclosure, wherein UV printing, laser printing, inkjet printing, or LED printing is applied to the QR code plate.

A process of forming the QR code plate include preparing a plate, coating an upper surface of the plate, coating a lower surface of the plate and completing the QR code plate in sequential order.

In the step of preparing the plate, a flooring plate 650 which is a base of the QR code plate and a notification layer (UV printing/laser printing/inkjet printing/LED printing) 630 are prepared as shown in FIG. 21.

That is, the flooring plate 650 functions as the main body of the QR code plate and is formed of a steel plate or an aluminum plate. In the case of a steel (Fe) plate, exposure to ambient temperature may cause rusting. Accordingly, in order to prevent corrosion and enhance the adhesion between the flooring plate 650 and the notification layer (UV printing/laser printing/inkjet printing/LED printing) 630, both sides of the steel plate are coated with a hot-dip coating solution including zinc Zn, aluminum Al, and magnesium Mg. In the event that the hot-dip coating solution is used, a non-colored (white) background is applied to enhance visibility and clarity of the information printed on the notification layer 630. Furthermore, the flooring plate 650 may be adhered well to uneven road surfaces such as concrete or stone pavement when installed.

The notification layer (UV printing/laser printing/inkjet printing/LED printing) 630 serves as the display (information) surface of the QR code plate and is prepared by forming an information display layer through the UV printing, the laser printing, the inkjet printing, or LED printing. The information display layer includes a QR code that guides the user to a page for inputting various types of information, as well as information including a parking area number, etc. In other words, the notification layer 630 is formed by performing the UV printing, the laser printing, the inkjet printing, or LED printing on the top surface of the notification layer 630. To enhance adhesion between the flooring plate 650 and the notification layer 630, a silicone-based layer or primer layer 640 may be formed on the upper surface of the flooring plate 650 to improve the print quality of the information layer.

The flooring plate 650 and the notification layer (UV printing/laser printing/inkjet printing/LED printing) 630 are configured to be stacked on top of each other so as to have a predetermined thickness. Accordingly, the total thickness is prepared in consideration of the height of the layers and coating materials described below.

The top surface coating step refers to a process of forming a protection layer by coating the upper surface of the notification layer (UV printing/laser printing/inkjet printing/LED printing) 630, as illustrated in FIG. 21, in order to protect it from external factors. The protection layer 620 is preferably formed by using a water-based epoxy resin or an epoxy resin to reduce the emission of volatile organic compounds. In order to enhance visibility or to provide a non-slip surface during nighttime or inclement weather, the protection layer 620 may be completed by preparing a mixed solution comprising a silica-based or oxide-based material. Although the protection layer 620 is preferably formed of a ceramic material, it is not limited thereto.

The step of forming the coating layer 610 applies spraying, coating, or silk screen printing to the prepared protection layer 620 to have a preset thickness. Although the coating layer 610 is preferably formed of a ceramic material, the composition of the coating layer 610 is not limited to ceramic-based materials.

The primer layer 640 described in the foregoing process may optionally be omitted.

On the other hand, the two-component ceramic coating composition (paint) usable in the coating layer 610 of the disclosure is characterized by simultaneously possessing durability and flexibility through the reaction between glycidyl groups and amino groups, as well as the self-hydrolysis reaction of silanol groups of the alumina sol oligomer. The coating composition may be completed through Steps 1 to 5.

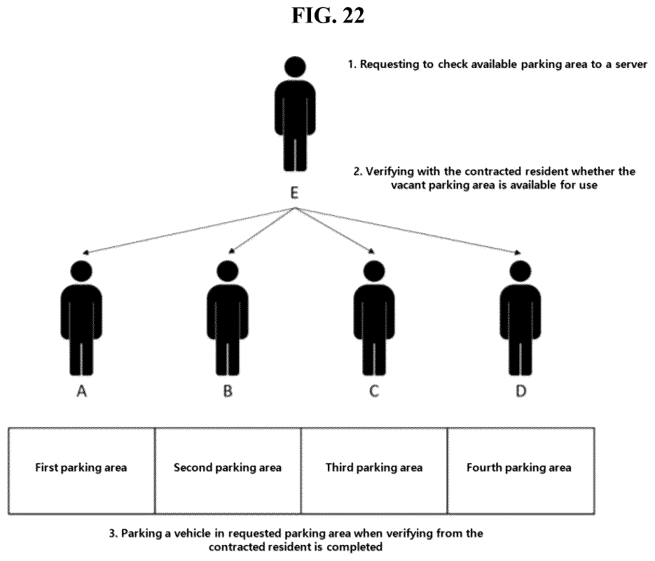

Hereinafter, a process in which an outsider performs parking in a resident parking area according to another embodiment of the disclosure will be described with reference to accompanying a drawing FIG. 22.

In FIG. 22, a first parking area to a fourth parking area exist in a resident parking area, and registered residents A to D are allowed to park in their respective parking areas during predetermined periods. In this case, when an outsider E attempts to park in one of the available parking areas among the first to fourth parking areas, a process proceeds as follows.

The outsider E requests available parking area to the server. In this case, the outsider E may check the parking status through cameras installed around the resident parking area. The server may provide information to a user terminal of the outsider E when the server determines that two or more of the plurality of parking areas are vacant.

Next, the outsider E may check with the registered resident of the vacant parking area whether use is permitted. The outsider E contacts the registered resident B or D, who is the contractor of the desired parking area, to request acceptance for parking when information indicating that the second parking area and the fourth parking area are available is transmitted from the server.

Once confirmation is received from the contractor, the outsider E performs parking in the requested parking area. For example, if the outsider E contacts the registered resident B to request parking permission and receives a response indicating that parking is not allowed, the outsider E may then contact the registered resident D to request parking permission. If confirmation is received indicating that parking is allowed, the outsider E may perform parking in the requested fourth parking area.

In another embodiment, patterns regarding the entry and exit times of the registered residents for each parking area within the resident parking area may be analyzed to identify the registered resident corresponding to a currently vacant parking area and to derive available time information indicating how many hours the corresponding parking area is expected to remain available.

In still another embodiment, an approach in accordance with the parking fee discount system is possible. The parking fee discount objects correspond to vehicles registered with local governments based on preset condition. These objects include, but are not limited to, people of national merit, people with disabilities, parents with multiple children, people eligible for military service benefits, electric vehicles, compact cars, and commercial vehicles. For each of the aforementioned objects, the discount rate set by the respective local government may be applied to the parking fee.

Necessary document for people of national merit, people with disabilities, parents with multiple children or people eligible for military service benefits among the objects mentioned above and information concerning their vehicles may be stored in the server and utilized. For compact cars and commercial vehicles (including cargo vehicles), an image learning model may be developed to identify them.

Then, vehicle information is identified from an image received from a camera of the parking lot when the parked vehicle exits, and discount information for the vehicle is automatically calculated. Based on this, the parking fee is automatically paid with the applied discounted amount. The process of automatically calculating the discount information is based on at least one of the following: information on discount objects stored in the server, information on the type of vehicle recognized through the camera's image, and the color of the license plate recognized by the camera. This allows for the application of at least one of the following discounts: electric vehicle discount, compact car discount, commercial vehicle discount, veteran discount, disability discount, and multiple-child parent discount.

The technical features described above can be implemented in the form of program instructions that may be performed using various computer means and can be recorded in a computer-readable medium. A computer-readable medium may be any available medium that can be accessed by a computer, and includes both volatile and non-volatile media, as well as removable and non-removable media. The computer-readable medium may include all forms of computer storage media. Computer storage media include all volatile and non-volatile, removable and non-removable media implemented in any method or technology for the storage of information such as computer-readable instructions, data structures, program modules, or other data.

The method and system of the disclosure have been described in connection with certain embodiments; however, some or all of their components or operations may be implemented using a computer system with general-purpose hardware architecture.

The above description of the disclosure is intended as illustrative, and it will be understood by those skilled in the art that various modifications can be made in specific forms without departing from the spirit or essential features of the disclosure. Therefore, the embodiments described above should be understood as illustrative rather than limiting in every respect. For example, each component described as being implemented in a singular form may be implemented in a distributed manner, and likewise, components described as being distributed may also be implemented in a combined form.

The scope of the disclosure is defined not by the foregoing detailed description but by the following claims, and all modifications or variations derived from the meaning and scope of the claims and their equivalents should be interpreted as being included within the scope of the disclosure.

1. A method of providing a parking system and proxy payment using a QR code executed by a server, the method comprising:
(a) transmitting parking area identification information from a user terminal to a server through capturing of a QR code installed to a parking area;
(b) completing an entry by storing an entry time and the parking area identification information in the server when the user terminal transmits phone number, license plate number and payment means information to the server, identifying stored location information related to the parking area identification information and transmitting an entry completion guidance message to the user terminal;
(c) providing a proxy payment QR code to the user terminal according to request of the user terminal; and
(d) identifying for a proxy payer terminal the proxy payment QR code from the user terminal, inputting proxy payment amount and performing proxy payment.

2. The method of claim 1, wherein the step of (d) includes:
providing difference between the proxy payment amount and payment amount to a service provider when multiple proxy payer terminals perform the proxy payment and the proxy payment amount exceeds the payment amount.

3. The method of claim 2, wherein the difference between the proxy payment amount and the payment amount is divided by the number of proxy payer terminals that performed the proxy payment and the resulting amount is refunded when setting based on the same refund amount standard.

4. The method of claim 2, wherein the difference between the proxy payment amount and the payment amount is refunded to the proxy payer terminals in proportion to the payment ratio of each proxy payer terminal relative to the proxy payment amount when setting to refund based on ratio of the proxy payment amount.

5. The method of claim 1, further comprising:
identifying the parking status of parking areas based on cameras installed around on-street parking lots, indoor parking lots and resident parking areas;
providing corresponding information to a first user terminal when it is determined that two or more parking areas of a plurality of parking areas or the on-street parking lots within a specific area are vacant;
requesting parking acceptance for one of two or more parking areas through a first user terminal;
transmitting the requesting of the parking acceptance to a terminal of a registered resident corresponding to vacant parking area; and
transmitting a reservation completion signal to the first user terminal when acceptance signals from a majority are received in response to the requesting of the parking acceptance,
wherein the step of the providing, the step of requesting, the step of transmitting the requesting and the step of transmitting the reservation completion signal are performed before the step of (a), and
the step of (b) includes analyzing patterns regarding entry and exit times of the registered resident to identify the registered resident corresponding to a vacant parking area and to derive available time information indicating how many hours the parking area will remain available.

6. The method of claim 1, further comprising:
pre-storing, in the server, information on parking fee discount-eligible persons, including persons of national merit, persons with disabilities, parents of multiple children, and persons eligible for veteran benefits, as well as the license plate numbers of those eligible vehicles; and
identifying a vehicle in an image captured by a camera and generating an image learning model for recognizing a type of the identified vehicle (compact car and commercial vehicle),
and wherein the step of pre-storing and the step of identifying are performed before the step of (a).

7. The method of claim 6, further comprising:
identifying vehicle information from an image transmitted from a camera of a parking lot, calculating automatically discount information regarding corresponding vehicle and paying automatically a parking fee to which discount is applied based on the calculating, after the step of (b).

8. The method of claim 7, wherein the calculating includes:
(p-1) applying at least one of electric vehicle discount, compact car discount, commercial vehicle discount, veteran discount, disability discount, and multiple-child parent discount based on one or more of the information about the fee discount objects stored in the server, the information concerning the kind of vehicle recognized through the image of the camera and color of a license plate recognized by the camera.

9. The method of claim 1, wherein the QR code installed in the parking area is formed with a QR code plate,
and wherein the QR code plate includes a flooring plate, a notification layer on which a QR image is formed through a laser method of printing directly on the flooring plate, a LED method or an inkjet method; and a protection layer for protecting the notification layer on the notification layer.

10. A server for providing proxy payment for a parking fee comprising:
a memory configured to store a program regarding a method of providing the proxy payment; and
a processor configured to execute the program,
wherein the method includes:
(a) providing a QR code for the proxy payment according to request of a beneficiary terminal;
(b) recognizing the QR code from the beneficiary terminal through a proxy payer terminal;
(c) receiving, by the proxy payer terminal, a payment amount to be paid from the server, inputting proxy payment amount and performing the proxy payment; and
(d) checking, by the beneficiary terminal, the updated payment amount from the server and paying the remaining amount.

11. The server of claim 10, wherein the step of (d) includes:
providing difference between the proxy payment amount and the payment amount to a service provider when multiple proxy payer terminals perform the proxy payment and the proxy payment amount exceeds the payment amount.

12. The server of claim 11, wherein the difference between the proxy payment amount and the payment amount is divided by the number of proxy payer terminals that performed the proxy payment and the resulting amount is refunded when setting based on the same refund amount standard.

13. The server of claim 11, wherein the difference between the proxy payment amount and the payment amount is refunded to the proxy payer terminals in proportion to the payment ratio of each proxy payer terminal relative to the proxy payment amount when setting to refund based on ratio of the proxy payment amount.

14. The server of claim 10, further comprising:
identifying the parking status of parking areas based on cameras installed around on-street parking lots, indoor parking lots and resident parking areas;
providing corresponding information to a first user terminal when it is determined that two or more parking areas of a plurality of parking areas or the on-street parking lots within a specific area are vacant;
requesting parking acceptance for one of two or more parking areas through a first user terminal;
transmitting the requesting of the parking acceptance to a terminal of a registered resident corresponding to vacant parking area; and
transmitting a reservation completion signal to the first user terminal when acceptance signals from a majority are received in response to the requesting of the parking acceptance,
wherein the step of the providing, the step of requesting, the step of transmitting the requesting and the step of transmitting the reservation completion signal are performed before the step of (a), and
the step of (b) includes analyzing patterns regarding entry and exit times of the registered resident to identify the registered resident corresponding to a vacant parking area and to derive available time information indicating how many hours the parking area will remain available.

15. The server of claim 10, further comprising:
pre-storing, in the server, information on parking fee discount-eligible persons, including persons of national merit, persons with disabilities, parents of multiple children, and persons eligible for veteran benefits, as well as the license plate numbers of those eligible vehicles; and
identifying a vehicle in an image captured by a camera and generating an image learning model for recognizing a type of the identified vehicle (compact car and commercial vehicle),
and wherein the step of pre-storing and the step of identifying are performed before the step of (a).

16. The server of claim 15, further comprising:
identifying vehicle information from an image transmitted from a camera of a parking lot, calculating automatically discount information regarding corresponding vehicle and paying automatically a parking fee to which discount is applied based on the calculating, after the step of (b).

17. The server of claim 16, wherein the calculating includes:
(p-1) applying at least one of electric vehicle discount, compact car discount, commercial vehicle discount, veteran discount, disability discount, and multiple-child parent discount based on one or more of the information about the fee discount objects stored in the server, the information concerning the kind of vehicle recognized through the image of the camera and color of the license plate recognized by the camera.

18. The server of claim 10, wherein the QR code installed in the parking area is formed with a QR code plate,
and wherein the QR code plate includes a flooring plate, a notification layer on which a QR image is formed through a laser method of printing directly on the flooring plate, a LED method or an inkjet method; and a protection layer for protecting the notification layer on the notification layer.
